(19) United States
(12) Patent Application Publication
(10) Pub. No.: US 2018/0080411 A1
(43) Pub. Date: Mar. 22, 2018

(54) GAS TURBINE ENGINE

(71) Applicant: General Electric Company, Schenectady, NY (US)

(72) Inventors: Brandon Wayne Miller, Liberty Township, OH (US); Donald Albert Bradley, Royal Oak, MI (US)

(21) Appl. No.: 15/267,680

(22) Filed: Sep. 16, 2016

(51) Int. Cl. F02K 3/06; F02C 3/10; F02C 7/36

(52) U.S. Cl. CPC F02K 3/06; F02C 7/36; F02C 3/10

(57) ABSTRACT

A gas turbine engine includes a fan section and a core turbine engine. The fan section includes a fan and a fan shaft, with the fan including a plurality fan blades rotatable with the fan shaft. The core turbine engine includes a turbine section having a first turbine and a second turbine. The core turbine engine additionally includes a spool rotatable with the second turbine. An epicyclic power gearbox is also provided including a sun gear rotatable with the spool, a ring gear, and a total of four or less planet gears engaged between the sun gear and the ring gear. The power gearbox is configured such that a fan pressure ratio defined by the fan is greater than about 1.05 and less than about 1.50 during operation of the gas turbine engine.

### FIELD OF THE INVENTION

The present subject matter relates generally to a gas turbine engine having a power gearbox designed in coordination with other gas turbine engine parameters.

### BACKGROUND OF THE INVENTION

Typical aircraft propulsion systems include one or more gas turbine engines. For certain propulsion systems, the gas turbine engines generally include a fan and a core arranged in flow communication with one another. Additionally, the core of the gas turbine engine general includes, in serial flow order, a compressor section, a combustion section, a turbine section, and an exhaust section. In operation, air is provided from the fan to an inlet of the compressor section where one or more axial compressors progressively compress the air until it reaches the combustion section. Fuel is mixed with the compressed air and burned within the combustion section to provide combustion gases. The combustion gases are routed from the combustion section to the turbine section. The flow of combustion gasses through the turbine section drives the turbine section and is then routed through the exhaust section, e.g., to atmosphere.

Typically, a high pressure turbine of the turbine section drives a high pressure compressor through a high pressure shaft, and a low pressure turbine drives a low pressure compressor through a low pressure shaft. The fan section may also be driven by the low pressure shaft. A direct drive gas turbine engine may include a fan section driven by the low pressure shaft such that the low pressure compressor, low pressure turbine, and fan section rotate at a common speed in a common direction.

By contrast, however, a geared gas turbine engine may include a power gearbox, also referred to as a speed reduction device, to step down a rotational speed of the low pressure shaft when driving the fan section, allowing the fan section to rotate at a speed different than the turbine section. This can provide for an overall increase in propulsive efficiency of the engine.

Although gas turbine engines utilizing speed power gearboxes are generally known to be capable of improved propulsive efficiency relative to conventional direct drive engines, it is generally desirous to continue to improve engine performance, which may include further improvements to propulsive efficiencies.

### BRIEF DESCRIPTION OF THE INVENTION

Aspects and advantages of the invention will be set forth in part in the following description, or may be obvious from the description, or may be learned through practice of the invention.

In one exemplary embodiment of the present disclosure, a gas turbine engine is provided. The gas turbine engine includes a fan section including a fan and a fan shaft. The fan includes a plurality of fan blades rotatable with the fan shaft. The fan defines a fan pressure ratio during operation of the gas turbine engine. The gas turbine engine also includes a core turbine engine, the core turbine engine including a turbine section having a first turbine and a second turbine. The core turbine engine additionally includes a spool rotatable with the second turbine. The gas turbine engine also includes an epicyclic power gearbox having a sun gear rotatable with the spool, a ring gear, and a total of four or less planet gears engaged between the sun gear and ring gear. The power gearbox is configured such that the fan pressure ratio defined by the fan is greater than about 1.05 and less than about 1.50 during operation of the gas turbine engine.

In another exemplary embodiment of the present disclosure, a gas turbine engine is provided. The gas turbine engine includes a fan section defining a fan pressure ratio during operation of the gas turbine engine, and a core turbine engine including a turbine section and a spool. The turbine section includes a first turbine and a second turbine and the spool is rotatable with the second turbine. The gas turbine engine also includes an outer nacelle defining a bypass passage with the core turbine engine. The gas turbine engine defines a bypass ratio of an airflow through the bypass passage to an airflow through the core turbine engine greater than about eleven (11). The gas turbine engine also includes an epicyclic power gearbox including a sun gear rotatable with the second turbine, a ring gear, and a total of four or less planet gears engaged between the sun gear and ring gear. The power gearbox is configured such that the fan pressure ratio defined by the fan is greater than about 1.05 and less than about 1.50 during operation of the gas turbine engine.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a schematic, cross-sectional view of a gas turbine engine in accordance with an exemplary aspect of the present disclosure.

FIG. 2 is a schematic, cross-sectional view of an epicyclic power gearbox in accordance with an exemplary aspect of the present disclosure.

FIG. 3 is a schematic, cross-sectional view of an epicyclic power gearbox in accordance with another exemplary aspect of the present disclosure.

FIG. 4 is a schematic, cross-sectional view of an epicyclic power gearbox in accordance with yet another exemplary aspect of the present disclosure.

FIG. 5 is a schematic, cross-sectional view of an epicyclic power gearbox in accordance with still another exemplary aspect of the present disclosure.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components. The terms “forward” and “aft” refer to relative positions within a gas turbine engine, with forward referring to a position closer to an engine inlet and aft referring to a position closer to an engine nozzle or exhaust. The terms “upstream” and “downstream” refer to the relative direction with respect to fluid flow in a fluid pathway. For example, “upstream” refers to the direction from which the fluid flows, and “downstream” refers to the direction to which the fluid flows.

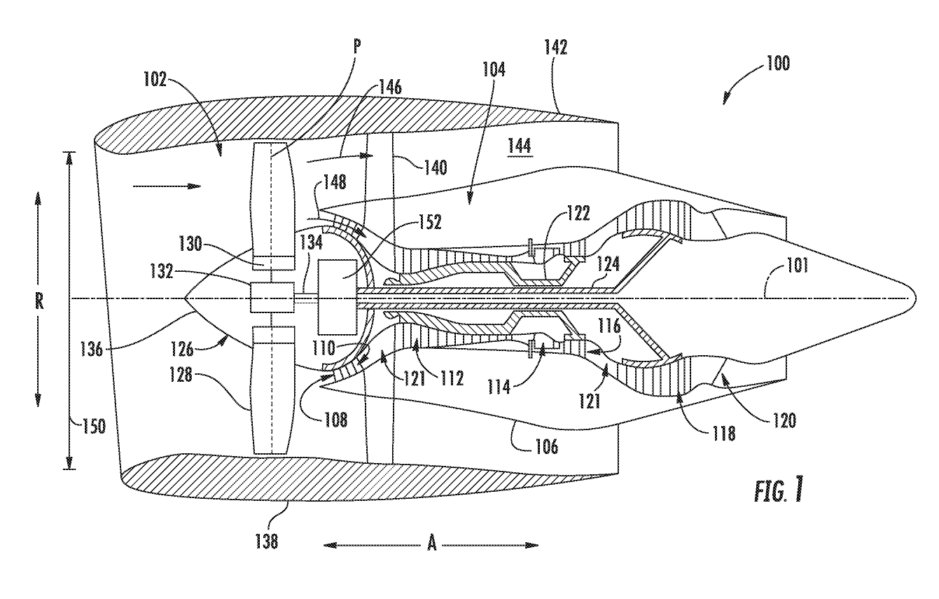

Referring now to the drawings, wherein identical numerals indicate the same elements throughout the figures, FIG. 1 provides a schematic cross-sectional view of a propulsion engine in accordance with an exemplary embodiment of the present disclosure. In certain exemplary embodiments, the propulsion engine may be configured a turbofan jet engine 100, herein referred to as “turbofan 100.” As shown in FIG. 1, the turbofan 100 defines an axial direction A (extending parallel to a longitudinal centerline 101 provided for reference), a radial direction R, and a circumferential direction C (extending about the axial direction A; not shown). In general, the turbofan 100 includes a fan section 102 and a core turbine engine 104 disposed downstream from the fan section 102.

The exemplary core turbine engine 104 depicted generally includes a substantially tubular outer casing 106 that defines an annular inlet 108. The outer casing 106 encases, in serial flow relationship, a compressor section including a second, booster or low pressure (LP) compressor 110 and a first, high pressure (HP) compressor 112; a combustion section 114; a turbine section including a first, high pressure (HP) turbine 116 and a second, low pressure (LP) turbine 118; and a jet exhaust nozzle section 110. The compressor section, combustion section 114, and turbine section together define a core air flowpath 121 extending from the annular inlet 108 through the LP compressor 110, HP compressor 112, combustion section 114, HP turbine section 116, LP turbine section 118 and jet nozzle exhaust section 120. A first, high pressure (HP) shaft or spool 122 drivingly connects the HP turbine 116 to the HP compressor 112. A second, low pressure (LP) shaft or spool 124 drivingly connects the LP turbine 118 to the LP compressor 110. Accordingly, the LP spool 124 is rotatable with the LP turbine 118 and the HP spool 122 is rotatable with the HP turbine 116.

For the embodiment depicted, the fan section 102 includes a fan 126 having a plurality of fan blades 128 coupled to a disk 130 in a spaced apart manner. As depicted, the fan blades 128 extend outwardly from disk 130 generally along the radial direction R. Notably, for the embodiment depicted, the fan 126 is a variable pitch fan. Accordingly, each fan blade 128 is rotatable relative to the disk 130 about a pitch axis P by virtue of the fan blades 128 being operatively coupled to a suitable actuation member 132 configured to vary the pitch of the fan blades 128, e.g., in unison.

Referring still to the exemplary embodiment of FIG. 1, the disk 130 is covered by rotatable front hub 136 aerodynamically contoured to promote an airflow through the plurality of fan blades 128. Additionally, the exemplary fan section 102 includes an annular fan casing or outer nacelle 138 that circumferentially surrounds the fan 126 and/or at least a portion of the core turbine engine 104. The nacelle 138 is supported relative to the core turbine engine 104 by a plurality of circumferentially-spaced outlet guide vanes 140. A downstream section 142 of the nacelle 138 extends over an outer portion of the core turbine engine 104 so as to define a bypass airflow passage 144 therebetween. Notably, it will be appreciated that the turbofan engine 100 defines a bypass ratio. Specifically, the term “bypass ratio” refers to a ratio of a bypass airflow 146 through the bypass passage 144 to a core airflow 148 through the core turbine engine, i.e., through the core air flowpath 121. For the embodiment depicted, the bypass ratio is greater than about six (6). More particularly, for the embodiment depicted, the bypass ratio of the turbofan engine 100 is at least about eight (8), such as at least about eleven (11).

Referring still to FIG. 1, the fan blades 128, disk 130, and actuation member 132 are together rotatable about the longitudinal axis 101 with a fan shaft 134 of the fan section 102, and more particularly, for the embodiment depicted, are rotatable about the longitudinal axis 101 by the fan shaft 134. Notably, the fan 126 defines a fan pressure ratio during operation of the turbofan engine 100. Specifically, the term “fan pressure ratio” refers generally to a pressure ratio across the plurality of fan blades 128. As will be described in greater detail below, the present turbofan engine 100 is configured such that the fan pressure ratio defined by the fan 126 is greater than about 1.05 and less than about 1.50 during operation of the turbofan 100. For example, in certain embodiments, the fan pressure ratio defined by the fan 126 during operation of the turbofan 100 is greater than about 1.10 and less than about 1.45.

Further, the fan 126 defines a fan diameter 150, which has been designed in coordination with various other components of the exemplary turbofan engine 100. For example, in certain embodiments, the fan diameter 150 may be less than about one hundred and fifteen (115) inches. For example, the fan diameter 150 may be less than about one hundred (100) inches, such as less than about (90) inches. It should be appreciated, that as used herein, terms of approximation, such as “about” or “approximate,” refer to being within a ten percent (10%) margin of error.

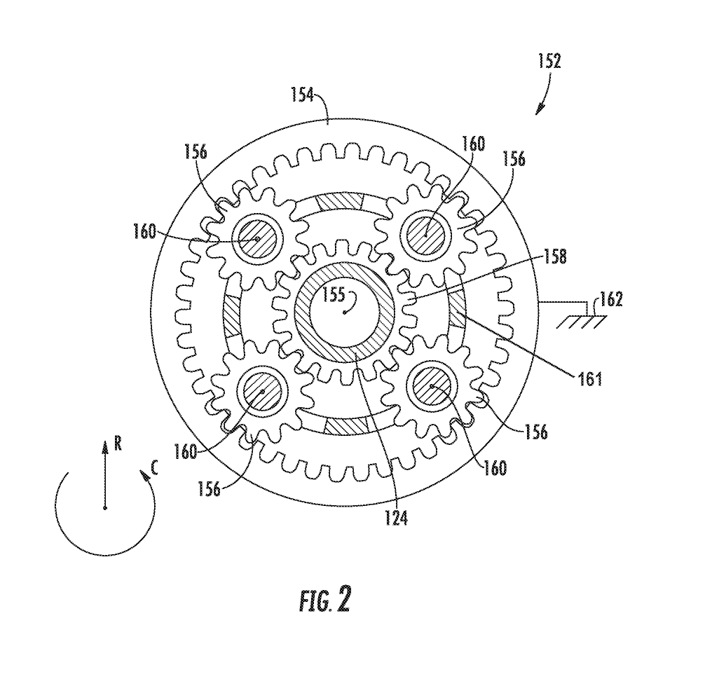

Referring still to FIG. 1, the fan 126 is rotatable by the LP shaft 124 across a reduction gearbox, or more particularly, an epicyclic power gearbox 152. As will be described below with reference to FIG. 2, the epicyclic power gearbox 152 includes a plurality of gears for stepping down a rotational speed of the LP shaft 124 to a more efficient rotational fan speed.

It should be appreciated, however, that the exemplary turbofan engine 100 depicted in FIG. 1 is provided by way of example only, and that in other exemplary embodiments, the turbofan engine 100 may have any other suitable configuration. For example, in other exemplary embodiments, the turbofan engine 100 may instead be configured as an unducted turbofan engine, or any other suitable gas turbine engine.

Referring now to FIG. 2, a close-up, schematic view of an epicyclic power gearbox 152 in accordance with an exemplary embodiment of the present disclosure is provided. The epicyclic power gearbox 152 may be incorporated into the turbofan engine 100 described above with reference to FIG. 1, or alternatively may be integrated into any other suitable gas turbine engine (e.g., a turboprop engine, an unducted turbofan engine, etc.). For this embodiment, the epicyclic power gearbox 152 is configured as a planetary gear assembly. Specifically, the epicyclic power gearbox 152 includes a ring gear 154, one or more planet gears 156, and a sun gear 158. The epicyclic gear box 152 defines a central axis 155. The sun gear 158 is attached to and rotatable with the LP spool 124, such that the sun gear 158 is rotatable by the LP turbine 118 and LP spool 124 about the central axis 155 of the epicyclic power gearbox 152. Additionally, for the embodiment depicted, the epicyclic power gearbox 152 includes a total of four or less planet gears 156 engaged between the sun gear 158 and the ring gear 154. Specifically, for the embodiment depicted, the epicyclic power gearbox 152 includes four planet gears 156 engaged between the sun gear 158 and the ring gear 154.

Each of the plurality of planet gears 156 are rotatable about a respective planet gear axis 160, and together attached to a planet gear carrier 161. Moreover, each of the exemplary planet gears 156 are single gears (i.e., the epicyclic power gearbox 152 is configured as a single-stage gearbox). It should be appreciated, however, that in other embodiments, the one or more planet gears 156 may instead be configured as compound gears defining any suitable gear ratio. For example, the compound gear may include two or more geared portions rotating together on a common gearshaft and meshing with respective mating gears at different axial positions (such that, e.g., the epicyclic power gearbox 152 defines multiple “stages”, as compared to the single-stage arrangement depicted). Additionally, the ring gear 154 is, for the embodiment depicted, a fixed ring gear 154 connected to a grounded structure 162 of the gas turbine engine. For example, the ring gear 154 may be attached to a forward frame or mid frame of the gas turbine engine (not shown). With such a configuration, the plurality of planet gears 156 are rotatable with the fan shaft 134 of the fan section 102, for driving the fan shaft 134 and fan 126 of the fan section 102. More particularly, each of the plurality of planet gears 156 are rotatably attached to the fan shaft 134 (about their respective planet gear axes 160 via the planet gear carrier 161), such that rotation of the planet gears 156 about the central axis 155 of the epicyclic gear box 152 directly, or indirectly through one or more intermediate components (not depicted), rotates the fan shaft 134.

For the embodiment depicted, the epicyclic power gearbox 152 defines a gear ratio, which generally refers to a ratio between a rate at which an input gear rotates (e.g., the sun gear 158) and a rate at which an output rotates (which, for the embodiment depicted is the plurality of planet gears 156). For the embodiment depicted, the gear ratio is greater than about two (2) and less than about ten (10). For example, in certain exemplary embodiments, the gear ratio may be greater than about two (2) and less than about five (5.0), or alternatively may be greater than about six (6) and less than about ten (10). The gear ratio may be coordinated with other components/design parameters (e.g., fan diameter, fan pressure ratio, etc.) of the engine to arrive at a desired engine. With such an epicyclic gear box configuration, including a desired gear ratio and number of planet gears 156, a gas turbine engine incorporating the exemplary epicyclic power gearbox 152 depicted may be designed such that fan 126 of the fan section 102 defines the desired fan pressure ratio (described above), while also allowing for the epicyclic power gearbox 152 to maintain a desired, relatively high power density and torque density.

More specifically, conventional power gearboxes have included at least five (or more) planet gears engaged between a ring gear and a sun gear so as to reduce undesirable harmonics generated by the gearbox during operation of the turbofan engine. However, the inventors of the present disclosure have unexpectedly discovered that by coordinating a design of the turbofan, as described herein, a power gearbox having a reduced number of planet gears is possible without concern for the undesirable harmonics that may otherwise be present. Accordingly, coordinating the design of the turbofan as described herein may allow for a power gearbox having a desired power and torque density.

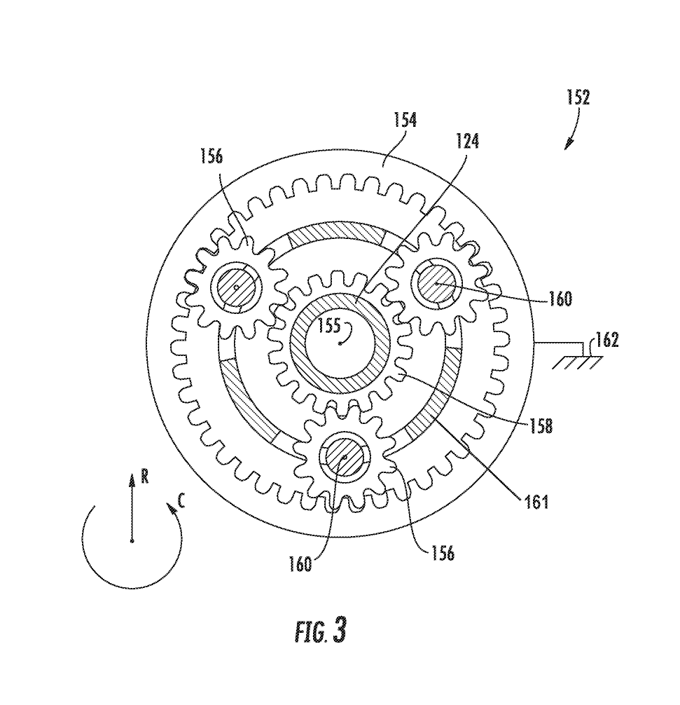

It should be appreciated, however, that in other embodiments, the epicyclic power gearbox 152 may instead have any other suitable configuration. For example, referring now to FIG. 3, an epicyclic power gearbox 152 in accordance with another exemplary embodiment of the present disclosure is provided. The exemplary epicyclic power gearbox 152 depicted in FIG. 3 may be configured in substantially the same manner as exemplary epicyclic power gearbox 152 described above with reference to FIG. 2. Accordingly, the same or similar numbers may refer to same or similar part.

For example, the exemplary epicyclic power gearbox 152 depicted in FIG. 3 generally includes a sun gear 158, a ring gear 154, and a plurality of planet gears 156 engaged between the sun gear 158 and the ring gear 154. However, for the embodiment depicted, the exemplary epicyclic power gearbox 152 includes a total of three or less planet gears 156 engaged between the sun gear 158 and the ring gear 154. Specifically, for the embodiment depicted, the exemplary epicyclic power gearbox 152 includes three planet gears 156 engaged between the sun gear 158 and the ring gear 154. When integrated within a gas turbine engine, such a configuration of epicyclic power gearbox 152 may allow for a more compact design, including a desired power density and overall efficiency of the gas turbine engine.

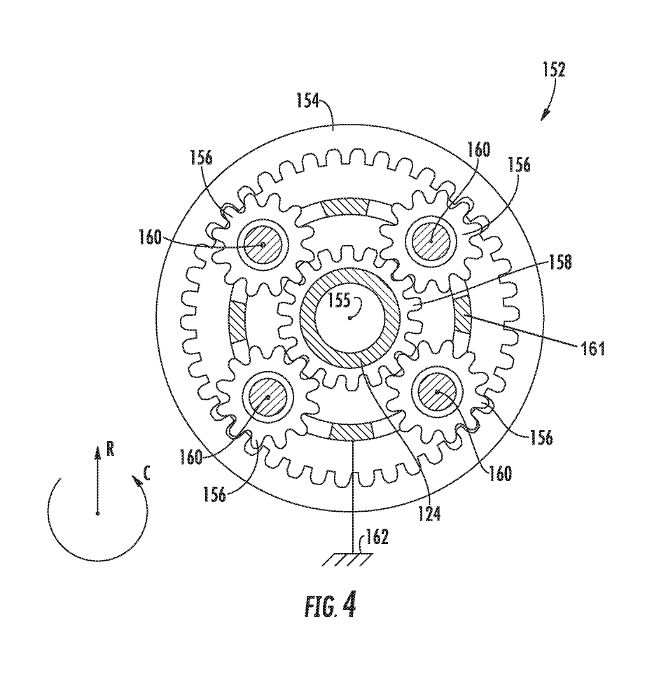

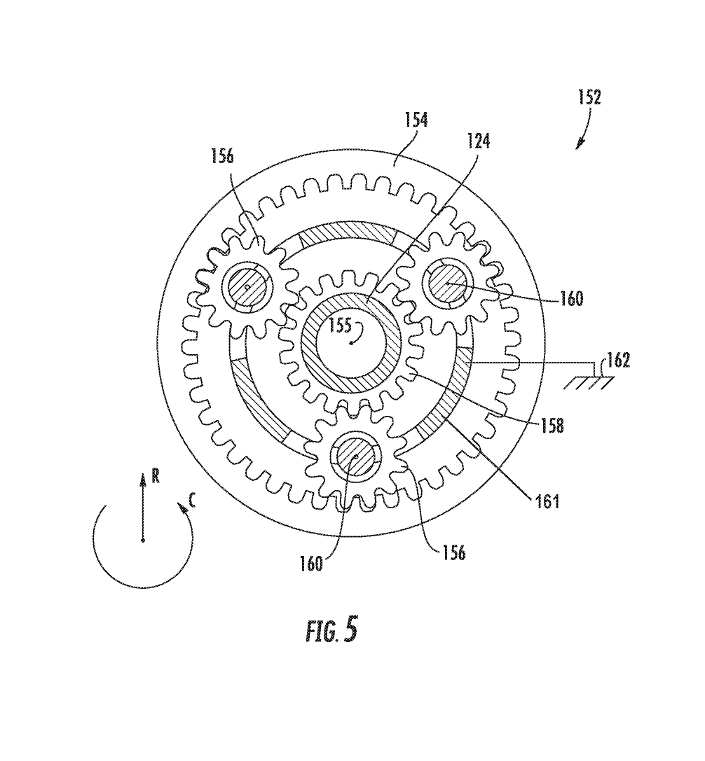

Moreover, it should be appreciated that the epicyclic power gearbox 152 may additionally, or alternatively, be configured in accordance with still other embodiments. For example, referring now to FIGS. 4 and 5, two additional epicyclic power gearboxes 152 configured in accordance with still other exemplary embodiments of the present disclosure are provided. The exemplary epicyclic power gearbox 152 depicted in FIG. 4 may be configured in substantially the same manner as exemplary epicyclic power gearbox 152 described above with reference to FIG. 2, and the exemplary epicyclic power gearbox 152 depicted in FIG. 5 may be configured in substantially the same manner as exemplary epicyclic power gearbox 152 described above with reference to FIG. 3. Accordingly, the same or similar numbers may refer to same or similar part.

For example, the exemplary epicyclic power gearboxes 152 depicted each also generally include a sun gear 158, a ring gear 154, and a plurality of planet gears 156 engaged between the sun gear 158 and the ring gear 154. However, for the embodiments depicted, the ring gears 154 are each attached to and rotatable with the fan shaft 134 of the fan section 102, for driving the fan shaft 134 and fan 126 of the respective fan section 102. With these configurations, the plurality of planet gears 156 (four plant gears 156 in FIG. 4 and three planet gears in FIG. 5), while rotatable about each of their respective axes 160, are mounted to a stationary planet gear carrier 161 and not rotatable about a central axis 155 of the epicyclic power gearbox 152.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A gas turbine engine comprising:
a fan section comprising a fan and a fan shaft, the fan including a plurality of fan blades rotatable with the fan shaft, wherein the fan defines a fan pressure ratio during operation of the gas turbine engine;
a core turbine engine, the core turbine engine comprising a turbine section comprising a first turbine and a second turbine, the core turbine engine additionally comprising a spool rotatable with the second turbine; and
an epicyclic power gearbox comprising a sun gear rotatable with the spool, a ring gear, and a total of four or less planet gears engaged between the sun gear and ring gear, the power gearbox configured such that the fan pressure ratio defined by the fan is greater than about 1.05 and less than about 1.50 during operation of the gas turbine engine.

2. The gas turbine engine of claim 1, wherein the power gearbox is configured such that the fan pressure ratio defined by the fan is greater than about 1.10 and less than about 1.45 during operation of the gas turbine engine

3. The gas turbine engine of claim 1, wherein the epicyclic gear assembly comprises a total of three or less planet gears engaged between the sun gear and ring gear.

4. The gas turbine engine of claim 1, wherein the four or less planet gears are rotatable about a central axis of the epicyclic power gearbox with the fan shaft of the fan section.

5. The gas turbine engine of claim 1, wherein the ring gear is rotatable with the fan shaft of the fan section.

6. The gas turbine engine of claim 1, wherein the epicyclic power gearbox defines a gear ratio greater than about 2.

7. The gas turbine engine of claim 1, further comprising:
an outer nacelle surrounding at least a portion of the fan section and the core turbine engine, wherein the outer nacelle defines a bypass passage with the core turbine engine.

8. The gas turbine engine of claim 7, wherein the gas turbine engine defines a bypass ratio of an airflow through the bypass passage to an airflow through the core turbine engine, and wherein the bypass ratio is greater than about six (6).

9. The gas turbine engine of claim 8, wherein the bypass ratio is greater than about eleven (11).

10. The gas turbine engine of claim 1, wherein the second turbine is a low pressure turbine, and wherein the spool is a low pressure spool.

11. The gas turbine engine of claim 1, wherein the fan of the fan section defines a fan diameter, and wherein the fan diameter is less than about one hundred and fifteen (115) inches.

12. The gas turbine engine of claim 1, wherein the gas turbine engine is a turbofan engine, and wherein the epicyclic power gearbox is a single-stage gearbox.

13. A gas turbine engine comprising:
a fan section defining a fan pressure ratio during operation of the gas turbine engine;
a core turbine engine comprising a turbine section and a spool, the turbine section comprising a first turbine and a second turbine, with the spool rotatable with the second turbine;
an outer nacelle defining a bypass passage with the core turbine engine, the gas turbine engine defining a bypass ratio of an airflow through the bypass passage to an airflow through the core turbine engine greater than about eleven (11); and
an epicyclic power gearbox comprising a sun gear rotatable with the second turbine, a ring gear, and a total of four or less planet gears engaged between the sun gear and ring gear, the power gearbox configured such that the fan pressure ratio defined by the fan is greater than about 1.05 and less than about 1.50 during operation of the gas turbine engine.

14. The gas turbine engine of claim 13, wherein the power gearbox is configured such that the fan pressure ratio defined by the fan is greater than about 1.10 and less than about 1.45 during operation of the gas turbine engine

15. The gas turbine engine of claim 13, wherein the epicyclic gear assembly comprises a total of three or less planet gears engaged between the sun gear and ring gear.

16. The gas turbine engine of claim 13, wherein the four or less planet gears are rotatable about a central axis of the epicyclic power gearbox with the fan shaft of the fan section.

17. The gas turbine engine of claim 13, wherein the ring gear is rotatable with the fan shaft of the fan section.

18. The gas turbine engine of claim 13, wherein the epicyclic power gearbox defines a gear ratio greater than about 2.

19. The gas turbine engine of claim 13, wherein the second turbine is a low pressure turbine, and wherein the core turbine engine further comprises a low pressure spool rotatable with the low pressure turbine, and wherein the sun gear of the epicyclic power gearbox is rotatable with the low pressure spool.

20. The gas turbine engine of claim 13, wherein the fan of the fan section defines a fan diameter, and wherein the fan diameter is less than about one hundred and fifteen (115) inches.
